(19) United States
(12) Patent Application Publication
(10) Pub. No.: US 2014/0271988 A1
(43) Pub. Date: Sep. 18, 2014

(54) ENHANCED EXTRACTS OF FOOD AND BEVERAGE COMPONENTS

(71) Applicant: STARBUCKS CORPORATION D/B/A STARBUCKS COFFEE COMPANY, Seattle, WA (US)

(72) Inventors: Urano A. Robinson, Sammamish, WA (US); J. Marcio Da Cruz, Issaquah, WA (US); Dien Van Vu, Kent, WA (US); Joseph Kuo, Seattle, WA (US)

(73) Assignee: STARBUCKS CORPORATION D/B/A STARBUCKS COFFEE COMPANY, Seattle, WA (US)

(21) Appl. No.: 14/213,982

(22) Filed: Mar. 14, 2014

Related U.S. Application Data
(60) Provisional application No. 61/799,208, filed on Mar. 15, 2013.

(51) Int. Cl. A23F 5/18; A23F 5/16

(52) U.S. Cl. CPC A23F 5/18; A23F 5/163
USPC 426/45; 426/431; 426/432; 426/594; 426/392

(57) ABSTRACT

Generally described are extracts and beverages with enhanced nutrients, flavors and textures and methods of making the same. Some embodiments relate to extracts and beverages produced through filtration techniques.

### INCORPORATION BY REFERENCE TO ANY PRIORITY APPLICATIONS

All applications for which a foreign or domestic priority claim is identified in the Application Data Sheet as filed with the present application are hereby incorporated by reference herein under 37 C.F.R. §1.57.

The present application claims a priority benefit under 35 U.S.C. §119(e) of U.S. Provisional Application Ser. No. 61/799,208, filed Mar. 15, 2013, the entirety of which is hereby incorporated by reference herein.

### BACKGROUND

A common method of producing an extract and/or a squeezed liquid from an edible substance involves crushing the edible substance and extracting it with solvent. However, in order to extract more desired compounds at higher concentrations, conventional methods such as heating to high temperatures, repeated heating, supercritical extraction, extended processing times, caustic organic solvents and others have been utilized.

Unfortunately, exposure to such harsh conditions used in conventional extraction processes can negatively impact flavors, colors, nutrients, antioxidants, polyphenols, vitamins, flavonoids, phytochemicals, neutraceuticals, and other compounds and qualities in the resulting extracts and beverages. Further, conventional solvent extraction alone cannot differentiate between compounds and components with similar solubilities. Therefore, to achieve improved beverages and extracts, improved methods of extraction and processing of extracts are being developed.

### BRIEF DESCRIPTION OF THE DRAWINGS

The foregoing aspects and many of the attendant advantages of the present disclosure will become more readily appreciated as the same become better understood by reference to the following detailed description, when taken in conjunction with the accompanying drawings, wherein:

FIG. 1 is a graph showing the naturally occurring percentages of caffeine, chlorogenic acids, starch, and sucrose in Sumatra Arabica, Brazil Arabica, Kenya Arabica, Columbia Arabica, and Robusta Vietnam coffee varieties.

FIG. 2 is a graph showing the naturally occurring percentages of fat, ash, and soluble fiber in Sumatra Arabica, Brazil Arabica, Kenya Arabica, Columbia Arabica, and Robusta Vietnam coffee varieties.

FIG. 3 is a graph showing the naturally occurring percentages of carbohydrates, protein, and insoluble fiber in Sumatra Arabica, Brazil Arabica, Kenya Arabica, Columbia Arabica, and Robusta Vietnam coffee varieties.

FIG. 4 is a radar graph showing the percentages of various components in green coffee extract before and after filtration according to some embodiments.

FIG. 5 is a graph showing the percentages of fat, starch, and caffeine in green coffee extract before and after filtration according to some embodiments.

FIG. 6 is a graph showing the percentages of ash, protein, carbohydrates, sucrose, and chlorogenic acids in green coffee extract before and after filtration according to some embodiments.

FIG. 7 is a graph showing the percentages of starch, protein, maltose, fructose, glucose, and fat in green coffee extract obtained with conventional refinement techniques compared to the percentages of these components after filtration according to some embodiments.

FIG. 8 is a graph showing the percentages of caffeine, chlorogenic acids, carbohydrates, ash, sucrose, and the ratio of chlorogenic acids to caffeine in green coffee extract obtained with conventional refinement techniques compared to the percentages of these components after filtration according to some embodiments.

FIG. 9 is a flowchart of a method of producing a coffee bean extract using water extraction and filtration according to some embodiments.

FIG. 10 is a graph showing the lightness and color profile of green coffee extracts obtained with conventional refinement techniques and green coffee extracts obtained with filtration according to some embodiments.

FIG. 11 is a radar graph showing the percentages of various components in green coffee extract obtained through filtration according to some embodiments.

### DETAILED DESCRIPTION

The following discussion is presented to enable a person skilled in the art to make and use one or more of the present embodiments. The general principles described herein may be applied to embodiments and applications other than those detailed below without departing from the spirit and scope of the disclosure. Therefore, the present embodiments are not intended to be limited to the particular embodiments shown, but are to be accorded the widest scope consistent with the principles and features disclosed or suggested herein.

Many beverage components have been found to contain antioxidants and other health promoting compounds. For example, recent studies indicate that consuming coffee can reduce the risk of Type 2 Diabetes, Parkinson's disease, heart disease, asthma and some forms of cancer. Tea has also been shown to have anti-cancer, anti-diabetes, anti-arthritis and anti-depressant properties. Therefore, much attention has been paid to the various compounds contained in these beverages and their possible uses as health supplements. Work has also been undertaken to extract from these edible raw materials the desired compounds thought to promote health in humans and animals.

During many conventional extraction techniques, high heat, repeated heating, supercritical extraction extended processing times and caustic organic solvents have been used to isolate desired chemical compounds from bulk raw material. However, these techniques used in the extraction process can result in the breakdown of desired compounds within the beverage components and the loss of desired components with similar solubility to that of undesired components. Due to the conventional thinking that extractions are best enhanced by chemically or thermally opening cells to separate compounds from bulk raw material, many variations of heat and solvents have been used in attempts to increase yield and obtain more desired compounds from edible sources with little success. Also, pressure has been used to bring carbon dioxide to its critical point in order to use it as a solvent for supercritical extraction, but such pressures have not sufficiently increased yields of desired compounds.

Extraction techniques employing organic solvents are widely used; however, such extraction techniques have distinct disadvantages not experienced with water extraction. Some of these disadvantages include, but are not limited to, denaturation and/or qualitative structural changes of compounds within the extracted material due to stresses associated with the organic solvent; dangers associated with flammable, explosive, and/or toxic solvents; high costs associated with particularized solvents and/or specialized equipment; solvent residues remaining in the final product and the related health concerns associated with the ingestion of such solvents; etc. Also, some cultural and religious tenets prohibit the consumption of food or beverages prepared using the organic solvent alcohol at any state of processing. Solvent extraction is also unable to distinguish, isolate, and remove from a product undesirable compounds that are soluble in the solvent.

Water extraction may be preferable to organic solvent extraction in some instances as it avoids the above disadvantages associated with organic solvent extraction. Further, water extraction is especially useful in the preparation of health, nutrition or supplement products due to the clean nature of water extraction and the absence of organic solvent residue in the product. However, water extraction is also unable to distinguish, isolate, and remove from a product undesirable compounds that are soluble in water.

In some embodiments, the use of filtration overcomes the above disadvantages to solvent or water extraction. For example, the combination of water extraction and filtration can avoid the negative aspects of organic solvent extraction while providing an extract with higher concentrations of desirable components and lower concentrations of undesirable components than is possible with organic solvent extraction or other techniques. In addition, some embodiments involving membrane filtration allow for significant yields of desired compounds using only water extraction that avoids the negative and unhealthy aspects of organic solvent extraction.

The membrane filtration utilized in some embodiments is able to differentiate molecules and particles in the extract based on the size of the molecule or particle rather than its solubility. In addition to avoiding the disadvantages associated with other extraction techniques, the present method is able to achieve particularized compounds in yields not obtainable through other extraction methods. In some embodiments, one filter is used. In other embodiments, two filters are used. In still other embodiments, three or more filters are used. The filters can be the same or different. In some embodiments, the each individual filter allows different sizes of particles to pass.

Some of the desired compounds present in certain edible raw materials include chlorogenic acids. In some embodiments, the yield of chlorogenic acids in an extract of the edible raw material is increased. Chlorogenic acids present in certain raw materials are powerful antioxidants thought to have advantageous metabolic, anti-hypertensive and weight loss inducing properties among others. In some embodiments, water extraction is used to extract chlorogenic acids from a food or beverage raw material. However, the concentration of chlorogenic acids from such an extraction may not be high enough to be fully effective. Further, the extract contains other undesirable components, many of that cannot be removed through extraction because the solubility of those components is similar to that of desired compounds like chlorogenic acids. Therefore, some embodiments relate to filtering an extract of an edible raw material in a way that increases the concentrations of desirable extract components and decreases the concentration of undesirable components. In some embodiments, multiple filtering processes are used to selectively manipulate component concentrations. The multiple filters may be different types of filters that allow different sizes of particles to pass. For example, a second or subsequent filter may filter out smaller molecular weight particles than the first filter.

In some embodiments, multiple filters are used. The filters can be used in any order or combination and each filter can be, for example, a 0.0001 μm filter, a 0.0005 μm filter, a 0.001 μm filter, a 0.002 μm filter, a 0.003 μm filter, a 0.004 μm filter, a 0.005 μm filter, a 0.006 μm filter, a 0.007 μm filter, a 0.008 μm filter, a 0.009 μm filter, a 0.01 μm filter, a 0.011 μm filter, a 0.012 μm filter, a 0.013 μm filter, a 0.014 μm filter, a 0.015 μm filter, a 0.016 μm filter, a 0.017 μm filter, a 0.018 μm filter, a 0.019 μm filter, a 0.02 μm filter, a 0.03 μm filter, a 0.04 μm filter, a 0.045 μm filter, a 0.05 μm filter, a 0.055 μm filter, a 0.06 μm filter, a 0.065 μm filter, a 0.07 μm filter, a 0.08 μm filter, a 0.09 μm filter, a 0.1 μm filter, a 0.11 μm filter, a 0.12 μm filter, a 0.13 μm filter, a 0.14 μm filter, a 0.15 μm filter, a 0.16 μm filter, a 0.17 μm filter, a 0.18 μm filter, a 0.19 μm filter, a 0.20 μm filter, a 0.25 μm filter, a 0.3 μm filter, a 0.4 μm filter, a 0.5 μm filter, a 0.6 μm filter, a 0.7 μm filter, a 0.8 μm filter, a 0.9 μm filter, a 1 μm filter, a 2 μm filter, a 3 μm filter, a 4 μm filter, a 5 μm filter, a 6 μm filter, a 7 μm filter, a 8 μm filter, a 9 μm filter or a 10 μm filter. In some embodiments, the filters can have from about <1K to about 500K MW CO (Molecular Weight Cut-Off).

Some embodiments relate to removing undesirable components from the extracts of the edible raw material. In some embodiments, fats are removed from an extract. In addition to dietary concerns, fats in edible products can be hazardous when they break down and can severely impact the composition of a food or beverage. In addition, fat contained in a food or beverage can greatly decrease the food or beverage's shelf life due to the tendency of fats to go rancid. Rancidity is caused by a biochemical reaction between fats and oxygen. In this process the long-chain fatty acids of fats are degraded and short-chain compounds are formed. One example of these reaction products is butyric acid, which contributes to the rancid taste and smell of spoiled fat-containing food or beverages. These free fatty acids can also undergo further auto-oxidation. Oxidation generally occurs with unsaturated fats by a free radical-mediated process. These chemical processes can generate highly reactive molecules in rancid foods and beverages, which produce unpleasant and noxious odors and flavors. In addition to decreasing shelf-life and freshness, these chemical processes may also destroy nutrients, vitamins and anti-oxidants in food or beverages. Some embodiments relate to filtering the extracts of edible raw material with one or more filters to reduce or eliminate fat from the extract. In addition to making possible a fat free product or substantially fat free product, the shelf life of such a product is greatly increased due to the absence or low presence of fat. The reduced fat reduces the incidence and severity of rancidity, thereby significantly increasing shelf life of the product.

Additionally, some embodiments relate to removing pigment compounds from an extract to affect the color of the extract. Many commercial uses of extracts require a lighter color so as not to occlude the desired color of the beverage. For example, all natural beverages that do not include added dyes or artificial additives often require specific color profiles of ingredients to ensure a final product that is pleasing to the eye. CIE L*a*b* (CIELAB) is a color measurement system specified by the International Commission on Illumination. This system describes all the colors visible to the human eye and serves as a device-independent model to be used as a reference.

The three coordinates of CIELAB represent the lightness of the color (L*=0 yields black and L*=100 indicates diffuse white; specular white may be higher), its position between red/magenta and green (a*, negative values indicate green while positive values indicate magenta) and its position between yellow and blue (b*, negative values indicate blue and positive values indicate yellow). The L*a*b* model is a three-dimensional model and can be represented in a three-dimensional space.

In some embodiments, an extract of an edible raw material can be filtered to remove compounds that cause a darker color or an undesirable color in the extract. For example, filtration of the green coffee extract shown in FIG. 10 led to an L* value of 83.09, an a* value of −2.59 and a b* value of 30.34. Such a product is considerably lighter with a green tint compared to the commercially available extracts that were darker and had a red tint. The above color properties of the extract are advantageous because they allow the extract to be added to a wider variety of food and beverage products. For example, lighter colored beverages such as lemon flavored, orange flavored, pineapple flavored, green tea flavored or apple flavored beverages require that any extracts added are sufficiently light to not impact the natural look of the beverage. Further, a lighter color in the extract allows for more of the extract to be added to a food or beverage product without significantly affecting the color of the product.

Also, some embodiments relate to removing components from an extract that cause a strong taste of the raw material from which the extract is prepared. In some embodiments, the extract can be filtered to remove compounds that cause a strong taste in the extract. Often, food or beverage products to which an extract is added have a unique desired taste with which the extract can interfere if the flavor of the extract is too strong. In some embodiments, extracts are filtered to dramatically reduce the flavor threshold amount of the extract. The flavor detection threshold is the lowest concentration of a certain flavor compound or compounds that are perceivable by the human sense of taste or smell. The threshold of a chemical compound is determined in part by its shape, polarity, partial charges and molecular mass. Table 1 below shows the significant increase in flavor threshold of an extract filtered in accordance with the present embodiments. As can be seen below, the flavor threshold increased by at least 35 times compared to commercially available extracts. This would indicate that roughly 35 times as much of the extract of the present embodiments could be added to a food or beverage without affecting the taste thereof compared to extracts obtained in conventional manners. As such, more of the desired compounds from the extract with health benefits and other advantages can be added to the food or beverage without impacting the desired flavor of the food or beverage.

TABLE 1

| | Flavor |
|---|---|
| | Threshold |
| Extract | ppm |
| Starbucks | 187.5 |
| GCE | |
| Commercial | 1.8 |
| Extract 1 | |
| Commercial | 5.1 |
| Extract 2 | |
| Commercial | 4.1 |
| Extract 3 | |

Non-limiting examples of desirable compounds extracted and maintained through processes according to the present embodiment include nutrients, antioxidants, polyphenols, vitamins, flavonoids, phytochemicals, neutraceuticals and other beneficial compounds. In some embodiments, polyphenols include compounds with a phenol ring with one or more hydroxyl groups covalently attached. For example, polyphenols include tannic acid, ellagic acid, vanillin, caffeic acid, chlorogenic acid, ferulic acid, catechins, epicatechin gallate, epigallocatechin, flavonols, anthocyanidins, quercetin, kaempferol, other flavonoids, and their glycosides and depsides. Furthermore, polyphenols may be in oligomeric or polymeric form such as oligomeric proanthocyanidins or condensed tannins.

In some embodiments, an edible substance can be extracted through the following process. First, the edible substance can be optionally pre-frozen and ground if necessary. Then, in some embodiments, the edible substance can be transferred to a plastic bag (e.g. a Scholle type bag) or an extraction chamber and combined with water. In some embodiments, the edible substance to water ratio can be from about 1:1 to about 1:20. In some embodiments, the ratio is about 1:2. Then the edible substance can be optionally pre-soaked in the water for from about 5 seconds to about 90 minutes. In some embodiments, the pre-soaking temperature can be from about 1° C. to about 180° C., from about 2° C. to about 150° C., from about 2° C. to about 100° C., from about 3° C. to about 80° C., from about 4° C. to about 60° C., from about 4° C. to about 50° C., from about 4° C. to about 40° C. or from about 4° C. to about 30° C. In some embodiments, the edible substance is not pre-soaked.

In some embodiments, the edible substance may be coffee, in other embodiments, the edible substance may be green coffee beans. In still other embodiments, the edible substance may be roasted whole coffee beans, for example, yellow coffee beans, red coffee beans, partially roasted coffee beans, dark roast coffee beans, light roast coffee beans, non-decaffeinated coffee, partially decaffeinated coffee, and fully decaffeinated coffee. The coffee used can be any variety or species from any part of the world. For example, Arabica, Robusta, and any blend of Arabica & Robusta from any part of the world (such as Brazil, Indonesia, Central America, Africa, etc). In yet other embodiments, the edible substance may be green tea leaves and/or partially or totally dehydrated tea leaves. In some embodiments, the edible substance may also be, in whole or in part, at least one of green coffee cherries, red coffee cherries, coffee flowers, coffee cherry skin, coffee cherry pulp, coffee cherry stalk, coffee cherry silverskin, coffee cherry mucilage, coffee cherry parchment, coffee cherry exocarp, coffee cherry mesocarp, vanilla beans, chocolate beans, hazelnuts, caramel, cinnamon, mint, eggnog, apple, apricot, aromatic bitters, banana, berry, blackberry, blueberry, celery, cherry, cranberry, strawberry, raspberry, juniper berry, brandy, cachaca, carrot, citrus, lemon, lime, orange, grapefruit, tangerine, coconut, cola, menthol, gin, ginger, licorice, hot, milk, nut, almond, macadamia nut, peanut, pecan, pistachio, walnut, peach, pear, pepper, pineapple, plum, quinine, rum, white rum, dark rum, sangria, shellfish, clam, tea, black tea, green tea, tequila, tomato, vermouth, dry vermouth, sweet vermouth, whiskey, bourbon whiskey, Irish whiskey, rye whiskey, Scotch whisky, Canadian whiskey, red pepper, black pepper, horseradish, wasabi, jalapeno pepper, chipotle pepper essential oils, resins, resinoids, balms, tinctures, soybean oil, coconut oil, palm oil, kern oil, sunflower oil, peanut oil, almond oil, cocoa butter, amyris oil, angelica seed oil, angelica root oil, aniseed oil, valerian oil, basil oil, tarragon oil, eucalyptus citriodora oil, eucalyptus oil, fennel oil, fir needle oil, galbanum oil, galbanum resin, geranium oil, grapefruit oil, guaiac wood oil, guaiac balsam, guaiac balsam oil, helichrysum absolute, helichrysum oil, ginger oil, iris root absolute, iris root oil, jasmin absolute, calmus oil, chamomile oil bleu, chamomile oil roman, carrot seed oil, cascarilla oil, pine needle oil, mint oil, carvi oil, labdanum oil, labdanum absolute, labdanum resin, lavandin absolute, lavandin oil, lavender absolute, lavender oil, lemongrass oil, Bursera penicillata (linaloe) oil, litsea-cubeba oil, bay laurel leaf oil, macis oil, marjoram oil, mandarin oil, massoirinde oil, mimosa absolute, ambrette seed oil, ambrette tincture, muskatelle salbei oil, nutmeg oil, orange blossom absolute, orange oil, oregano oil, palmarosa oil, patchouli oil, perilla oil, parsley leaf oil, parsley seed oil, clove seed oil, peppermint oil, pepper oil, pimento oil, pine oil, poley oil, rose absolute, rose wood oil, rose oil, rosemary oil, sage oil, lavandin, sage oil Spanish, sandalwood oil, celery seed oil, lavender spike oil, star anis oil, styrax oil, tagetes oil, pine needle oil, tea-tree oil, turpentine oil, thyme oil, tolu balm, tonka absolute, tuberose absolute, vanilla extract, violet leaf absolute, verbena oil, vetiver oil, juniper berry oil, wine yeast oil, wormwood oil, wintergreen oil, ylang ylang oil, hyssop oil, civet absolute, cinnamon leaf oil, cinnamon bark oil or any other type of food flavoring or edible substance.

In some embodiments the edible raw material is extracted by any method. For example, extraction under pressure of 10 bar or greater, or extraction under low pressure (less than 1 bar) can be used. Further, ultrasonic extraction, electric field extraction, microwave extraction and/or pulsed field extraction can be used. In some embodiments, oxygen can be removed from the water used in the extraction prior to the extraction process to further reduce exposure of the extract to oxidation.

In some embodiments, the edible raw material is placed in an extraction chamber and extracted either with or without added pressure. The extraction can be carried out for varying amounts of time depending on the type and amount of the edible substance being extracted. In some embodiments, the extraction can be performed for from about 1 minute to about 24 hours, from about 2 minutes to about 12 hours, from about 2 minutes to about 6 hours, from about 2 minutes to about 1 hour, from about 2 to about 40 minutes, from about 2 to about 10 minutes or from about 3 to about 5 minutes. The extraction temperature can also be varied depending on the type and amount of the edible substance being extracted. In some embodiments, the extraction temperature can be from about 1° C. to about 180° C., from about 2° C. to about 150° C., from about 2° C. to about 100° C., from about 3° C. to about 80° C., from about 4° C. to about 60° C., from about 4° C. to about 50° C., from about 4° C. to about 40° C. or from about 4° C. to about 30° C. In some embodiments, the temperature fluctuates during the extraction. In some embodiments, if the edible substance is frozen when extraction begins, the temperature of the edible substance and the extraction medium may be different and may equilibrate during the extraction process.

After extraction, the resulting material can be optionally post-soaked in the extraction medium for from about 5 seconds to about 90 minutes. In some embodiments, the post-soaking temperature can be from about 1° C. to about 180° C., from about 2° C. to about 150° C., from about 2° C. to about 100° C., from about 3° C. to about 80° C., from about 4° C. to about 60° C., from about 4° C. to about 50° C., from about 4° C. to about 40° C. or from about 4° C. to about 30° C. The extraction chamber or bag can then be drained, the liquid extract maintained and the spent solid material either discarded or maintained for other uses, for example, agricultural purposes. In some embodiments, the spent solid material can undergo one or more additional passes of optional pre-soaking, extraction and post-soaking as described above. The resulting liquid extract from the one ore more additional extractions can be combined with the original liquid extract for processing or processed separately. After extraction, the liquid extract can then be concentrated, filtered and dried as discussed below. The dried product can be ground to a mean particle size of from about 1 to about 5000 microns, about 2 to about 1000 microns, about 3 to about 500 microns, about 4 to about 400 microns or from about 5 to about 300 microns and packaged as discussed below.

The liquid extract can then be filtered in the presence or absence of heat or pressure. In some embodiments, the filtering is done using membrane filters. Non-limiting examples of materials used for such membrane filters include cellulose acetates, ceramics, cellulose esters, polyamides, etc. The types of filtration are also not limited and include, for example, nanofiltration, ultrafiltration, microfiltration, reverse osmosis filtration, and any combination of these. Membrane filters can be obtained from Koch Filter Corporation (Louisville, Ky.) or Millipore Inc. (Billerica, Mass.), for example. Non-limiting examples of suitable membrane filters are a ROMICON® filter made by Koch or an AMICON® filter made by Millipore. Pore diameters of such filters may be from about 0.001 microns to about 0.5 microns and from about <1K to about 500K MWCO (Molecular Weight Cut-Off). In some embodiments, the edible substance or extract is filtered using ultrafiltration. In other embodiments a combination of filtration methods such as reverse osmosis, nanofiltration, ultrafiltration and microfiltration is used. Membrane filters can also be used in the present embodiments to concentrate solutions and remove water, salts and proteins, for example. After filtration, the unwanted materials such as high molecular weight proteins, starch, ash and bacteria blocked by the filter can be maintained or discarded. The liquid passing through the filter is usually maintained as the product of the filtration.

In order to facilitate filtration and other processing of an extract component, the extract component can be concentrated by removing water and salts, for example. In addition, concentration of beverage components can make the beverage component easier to process, sterilize, transport and store. In some embodiments, the extract component can be concentrated using the above-described filtration techniques. In other embodiments, the extract component can be concentrated using other techniques, such as freeze concentration. Freeze concentration involves concentration by partial freezing of an edible substance or extract and subsequent separation of the resulting ice crystals leaving a liquid concentrate. Other methods of concentration include low temperature/low pressure gentle thermal evaporation or high vacuum, low temperature evaporation, for example. Some embodiments provide concentration through a combination of the above methods. For example, the edible substance or extract can be concentrated through a combination of membrane filtration and non-membrane concentration. More specifically, concentration of the edible substance or extract can be carried out through a combination of reverse osmosis filtration and freeze concentration. In other embodiments, the edible substance or extract can be concentrated through a combination of different types of filtration such as ultra filtration and reverse osmosis filtration. In still other embodiments, the edible substance or extract can be concentrated through a combination of more than one non-filtration techniques such as a combination of freeze concentration and low temperature/low pressure gentle thermal evaporation.

Drying the extract after extraction and filtration should be done carefully to avoid exposure to high heat, repeated heating or oxygen, which could damage the taste, aroma and compounds of the extract. Also, care should be taken when drying to avoid any conditions that may contaminate the extract with bacteria or other contaminants. Non-limiting examples of methods of drying an extract include freeze drying, spray drying, filter-mat drying, fluid bed drying, vacuum drying, drum drying, zeodration, etc, or any combination thereof. Zeodration involves drying with zeolites. Zeolites are materials containing pores, which allow the passage of water, but do not allow the passage of certain other materials. Drying by zeodration involves placing the wet solution in contact with zeolites, drawing only the water into the zeolites and then removing the zeolites, leaving a dried product.

In some embodiments, vacuum drying can be carried out at from about 0.05 mbar to about 0.5 mbar at a temperature of from about −40° C. to about 0° C. In some embodiments, vacuum drying can be carried out at from about 10 mbar to about 40 mbar at a temperature of from about −20° C. to about 0° C. Freeze drying can be carried out at from about 0.5 mbar to about 50 mbar and at a temperature of from about −20° C. to about 0° C. In addition, if water is to be removed by sublimation, the pressure during freeze drying may be below about 6 mbar and the temperature below about 0° C. In some embodiments, zeodration can be carried out at a pressure of from about 0.1 to about 50 mbar and a temperature of from about 10° C. to about 60° C. Temperature and pressure ranges can be monitored carefully to obtain sublimation of water only, which leaves intact the product flavor, aroma and desired compounds. In one example, the extract can be dried at a temperature lower than about −11° C. to preserve substantially all flavor properties. In some embodiments, the temperature can be below about 0° C. until the last stage of the drying (for example, from about 5% to about 8% moisture) and the temperature can then be raised above about 0° C. In some embodiments, the length of time that the extract undergoes drying is minimized to avoid degradation of flavor.

The above-described methods of extracting and processing an edible substance can be performed in many different combinations and with a wide variety of variables. For example, in some embodiments all of filtration, concentration, sterilization and drying are used in the preparation of an extract. In other embodiments, only filtration, concentration and sterilization are used. In still other embodiments, only filtration and concentration are used. In yet other embodiments, only concentration and drying are used. In some embodiments, filtration and drying are used.

FIGS. 1, 2 and 3 illustrate the naturally occurring concentration of caffeine, chlorogenic acids, starch, sucrose, ash, protein, insoluble fiber, soluble fiber, fat, and carbohydrates by weight percent in various coffee bean varieties including Sumatra Arabica, Brazil Arabica, Kenya Arabica, Columbia Arabica, and Robusta Vietnam. The Arabica varieties have roughly half as much caffeine as the Robusta variety and around two-thirds as much chlorogenic acids content. Arabica beans also have more sucrose and lipids than Robusta beans. These differences in concentration may ultimately be reflected in the extracted product. Accordingly, a Robusta extract may naturally have more caffeine and chlorogenic acids than the Arabica varieties. Despite low caffeine and chlorogenic acids content, Arabica beans may be a preferred variety due to, among other things, flavor and aroma considerations. Due to this preference, it may be desirable to use an Arabica variety and filter out the undesired components such as fat while increasing the caffeine and/or chlorogenic acids content in the remaining permeate. Extraction and filtration according to some embodiments allows the use of Arabica varieties as the raw product while still permitting high yields of desirable compounds such as caffeine and chlorogenic acid in the extract product.

FIG. 4 is a radar graph illustrating the concentrations in weight percent of ash, protein, carbohydrates, fat, starch, sucrose, glucose, fructose, caffeine, and chlorogenic acids in liquid coffee extract before and after filtration with a single 10,000 molecular weight filter. Before filtration, the liquid extract comprises relatively low levels of chlorogenic acids and caffeine. After filtration the percentage of chlorogenic acids and caffeine dramatically increase while the percentages of fat, glucose, and fructose decrease.

FIGS. 5 and 6 illustrate the concentrations of fat, ash, starch, caffeine, ash, protein, carbohydrates, sucrose, and chlorogenic acid by weight percent in green coffee extract before filtration, after filtration with a 10,000 molecular weight filter and after filtration with first at 10,000 molecular weight filter and then a second 5,000 molecular weight filter. Before filtration, the extract starts contains approximately three percent fat. This amount decreases to 0.76% fat after the first filtration and is fat free after the second filtration. Protein and ash concentrations are also decreased as a result of multiple filtration. Caffeine concentrations dramatically rise, from 3.75% after extraction to 6.76% after the first filtration with the 10,000 molecular weight membrane and 7.39% after a second filtration with a 5,000 molecular weight membrane. Chlorogenic acids concentrations increase from 10.57% after extraction to 22.08% after the first filtration with the 10,000 molecular weight filter and 27.09% after the second filtration with the 5,000 molecular weight filter.

FIGS. 7 and 8 illustrate the concentration profile of an extract obtained through methods according to some embodiments compared with extractions obtained through conventional extraction techniques. The extract obtained through methods according to some embodiments has an absence of fat while the extracts obtained through conventional technique contain over 3% fat. The technique described in the present embodiments also allows for high concentrations of caffeine and chlorogenic acids despite employing water extraction and using an Arabica variety as a raw material. Other commercially available techniques usually start with Robusta varieties and thus are able to obtain a higher percent of caffeine and chlorogenic acids in their extract despite less selective and/or effective extraction processes.

FIG. 9 shows an overview of one embodiment of a method for preparing an extract of green coffee beans, immature green coffee cherries and/or red coffee cherries. In this embodiment, green coffee beans, immature green coffee cherries and/or red coffee cherries to be extracted as shown in block 901 can undergo grinding if needed as shown in block 902. In one embodiment, the resulting particle size after grinding is 90 to 1000 micron and the coffee can be pre-frozen before grinding if desired. The ground product then undergoes extraction by water as shown in block 904. This process may involve placing the ground product in a plastic bag, such as a Scholle type bag, or directly into a chamber. Optionally, the ground product can be pre-soaked for 0.5 to 30 minutes. The temperature for pre-soaking can be from 5 to 150° C. Then the ground product undergoes extraction with a product to water ratio of from 1:1 to 1:24. After extraction, the product can optionally undergo post-soaking for 0.5 to 30 minutes. The liquid from the bag or chamber is then drained and then can then be dried by any number of alternative drying methods. Non-limiting examples of drying methods include spray drying, freeze drying or any other type of drying such as filter-mat drying, fluid bed drying, vacuum drying, drum drying, zeodration, a combination thereof etc. The dried product is then ground to a size of 5 to 300 micron and packaged. Alternatively, the liquid from the bag or chamber, after optional post-soaking as shown, can be drained, separated as shown in block 905 into spent material as shown in block 906 and premium raw extract as shown in block 907. The spent material as shown in block 906 can either be discarded or undergo one or more additional extractions to produce reclaimed extract, which can be added to the premium extract or processed separately. The premium raw extract shown in 907 and/or the reclaimed raw extract can be filtered as shown in block 908. After filtration the retentate as shown in block 909 can be separated from the permeate as shown in block 910. The permeate as shown in block 910 can optionally undergo a second filtration as shown in block 911 where again the retentate can be separated out (not shown). The permeate as shown in block 910 or 912 can then undergo evaporation as shown in block 913 before being condensed as shown in block 914. The condensed liquid extract can then be spray dried as shown in block 915 to produce an extract powder as shown in block 916. However, in some embodiments, the extract can be partially dried after filtration and not concentrated. The resulting product can then be further dried as required at a later stage of processing or combination with a food or beverage product.

FIG. 10 illustrates the lightness and color of the extract obtained according to some embodiments compared with the lightness and color of the extract obtained using conventional extraction techniques. The extract obtained with one or two filtrations is significantly lighter than those obtained through conventional methods. It also has a green-yellow hue as compared with the reddish hue of extracts obtained with conventional techniques.

FIG. 11 is a radar graph illustrating the concentrations in weight percent of ash, protein, carbohydrates, fat, starch, sucrose, glucose, fructose, caffeine, and chlorogenic acids in liquid coffee extract before filtration, after filtration with a 10,000 molecular weight filter, and again after filtration with first a 10,000 molecular weight filter and second a 5,000 molecular weight filter. After filtration the percentage of chlorogenic acids and caffeine dramatically increase while the percentage of fat, glucose, and fructose decrease.

In some embodiments, sugar can be added to the extract or beverage at any time during processing, such as before extraction, during extraction, after extraction, during drying, after drying, after grinding or after packaging. Non-limiting examples of sugar include cane sugar, fructose, corn syrup, dextrose, malto-dextrose, maltodextrin, glycerine, threitol, erythritol, xylitol, arabitol, ribitol, sorbitol, mannitol, maltitol, maltotriitol, maltotetraitol, lactitol, hydrogenated isomaltulose, hydrogented starch, shellac, ethyl cellulose, hydroxy propyl methylcellulose, starches, modified starches, carboxyl cellulose, carrageenan, cellulose acetate phthalate, cellulose acetate trimellitate, chitosan, corn syrup solids, dextrins, fatty alcohols, hydroxy cellulose, hydroxy ethyl cellulose, hydroxy methyl cellulose, hydroxy propyl cellulose, hydroxy propyl ethyl cellulose, hydroxy propyl methyl cellulose, hydroxy propyl methyl cellulose phthalate, polyethylene glycol or a combination thereof.

Also, additional flavoring can be added to the extract or beverage at any time during processing, such as before extraction, during extraction, after extraction, during drying, after drying, after grinding or after packaging. Non-limiting examples of flavoring include vanilla, chocolate, hazelnut, caramel, cinnamon, mint, eggnog, apple, apricot, aromatic bitters, banana, berry, blackberry, blueberry, celery, cherry, cranberry, strawberry, raspberry, juniper berry, brandy, cachaca, carrot, citrus, lemon, lime, orange, grapefruit, tangerine, coconut, cola, menthol, gin, ginger, licorice, hot, milk, nut, almond, macadamia nut, peanut, pecan, pistachio, walnut, peach, pear, pepper, pineapple, plum, quinine, rum, white rum, dark rum, sangria, shellfish, clam, tea, black tea, green tea, tequila, tomato, top note, tropical, vermouth, dry vermouth, sweet vermouth, whiskey, bourbon whiskey, Irish whiskey, rye whiskey, Scotch whisky, Canadian whiskey, red pepper, black pepper, horseradish, wasabi, jalapeno pepper, chipotle pepper essential oils, concretes, absolutes, resins, resinoids, balms, tinctures, soybean oil, coconut oil, palm oil, kern oil, sunflower oil, peanut oil, almond oil, cocoa butter, amyris oil, angelica seed oil, angelica root oil, aniseed oil, valerian oil, basil oil, tarragon oil, eucalyptus citriodora oil, eucalyptus oil, fennel oil, fir needle oil, galbanum oil, galbanum resin, geranium oil, grapefruit oil, guaiac wood oil, guaiac balsam, guaiac balsam oil, helichrysum absolute, helichrysum oil, ginger oil, iris root absolute, iris root oil, jasmin absolute, calmus oil, chamomile oil bleu, chamomile oil roman, carrot seed oil, cascarilla oil, pine needle oil, mint oil, carvi oil, labdanum oil, labdanum absolute, labdanum resin, lavandin absolute, lavandin oil, lavender absolute, lavender oil, lemongrass oil, Bursera penicillata (linaloe) oil, litsea-cubeba oil, bay laurel leaf oil, macis oil, marjoram oil, mandarin oil, massoirinde oil, mimosa absolute, ambrette seed oil, ambrette tincture, muskatelle salbei oil, nutmeg oil, orange blossom absolute, orange oil, oregano oil, palmarosa oil, patchouli oil, perilla oil, parsley leaf oil, parsley seed oil, clove seed oil, peppermint oil, pepper oil, pimento oil, pine oil, poley oil, rose absolute, rose wood oil, rose oil, rosemary oil, sage oil, lavandin, sage oil Spanish, sandalwood oil, celery seed oil, lavender spike oil, star anis oil, styrax oil, tagetes oil, pine needle oil, tea-tree oil, turpentine oil, thyme oil, tolu balm, tonka absolute, tuberose absolute, vanilla extract, violet leaf absolute, verbena oil, vetiver oil, juniper berry oil, wine yeast oil, wormwood oil, wintergreen oil, ylang ylang oil, hyssop oil, civet absolute, cinnamon leaf oil, cinnamon bark oil etc. any other type of food flavoring or edible substance or a combination thereof.

In some embodiments, the extract can also be combined with concentrated liquid coffee (with 5-80% solids for example), soluble coffee or instant coffee. Adding extract to food and beverage products can result in significantly extending the shelf life of the food or beverage. Coffee and other products subjected to processing such as that necessary to make an instant form of the product go through flavor and aroma changes. These changes come from the altering of the initial bonded structures of the compounds within the products. With coffee, for example, any kind of processing can alter the bonded structures of the compounds found in unprocessed coffee beans. Some embodiments include a method of adding or restoring the flavor and aroma associated with an unprocessed food product to a processed or instant version of the product. In some embodiments, the product is coffee. Some embodiments include methods involving pulverization of an edible substance, for example, roasted coffee beans, green tea leaves and/or partially or totally dehydrated tea leaves, cocoa beans or other food ingredients as a means of adding or restoring freshness, flavor and aroma of, for example, soluble coffee, teas, chocolates, etc. Some embodiments also allow for the introduction of different and unique flavors and aromas into food products as well as the introduction of compounds from extracts into food and beverage products.

In some embodiments, the pulverized edible substance or extract has a mean particle size, in diameter, of less than about 2000 microns, 1500 microns, 1000 microns 900 microns, 800 microns, 700 microns, 600 microns, 500 microns, 450 microns, 400 microns, 350 microns, 300 microns, 250 microns in diameter, 200 microns, 150 microns, 100 microns, or 50 microns.

In some embodiments, the pulverized edible substance or extract has a median particle size, in diameter, of less than about 2000 microns, 1500 microns, 1000 microns 900 microns, 800 microns, 700 microns, 600 microns, 500 microns, 450 microns, 400 microns, 350 microns, 300 microns, 250 microns in diameter, 200 microns, 150 microns, 100 microns, or 50 microns.

Extract exposure to oxygen can be minimized using conventional methods, for example, nitrogen purging, vacuum packaging, etc. In some embodiments, the extract can be placed in a container with an oxygen content of from about 0.1% to about 21%. Also, liquid nitrogen can be used as an oxygen scavenger during processing to minimize the degradative effects of oxygen.

Any type of grinding equipment can be used in the present embodiments to grind the edible substance, or to grind the extract. Non-limiting examples of grinding equipment include a cage mill, a hammer mill, a single-stage roller grinder, a multistage roller grinder, etc. In some embodiments, the equipment is maintained at very low temperatures (−200° C. to 20° C.) via cooling media. This helps maintain the integrity of the substance being pulverized or ground. Liquid nitrogen and/or carbon dioxide or other refrigerants can be used to cool the equipment. Grinding generates heat, which combined with exposed oxygen, can often degrade the extract product. Feeding liquid nitrogen and/or carbon dioxide to the grinding cavity is one example of a way to keep the grinding machine at low temperatures as well as displacing and scavenging oxygen. In some embodiments, the temperature during grinding can be as high as 90° C.

Some embodiments include packaging the extract. In some embodiments the ground or pulverized extract product falls into a refrigerated container at from about 0° C. to about 20° C. In some embodiments the ground or pulverized product falls into a refrigerated container at less than about 20° C. Some embodiments involve using liquid nitrogen and/or carbon dioxide cooling of the container including liquid or gas nitrogen inside the container for product preservation. Other embodiments involve liquid or gas carbon dioxide, CO₂ pellets, liquid or gas argon, air or other inert gases. During operation, the discharging cavity should be continually flushed with gaseous nitrogen to minimize oxidation. In some embodiments, the operation takes place under controlled environmental conditions to protect the resulting product from moisture uptake.

In some embodiments, in order to ensure quality, the final product is moved to an oxygen free environment, vacuum packed, sealed and stored under deep freeze conditions (about −20° C. or colder), until used or sold.

In some embodiments, the integrity of the extract can also be protected by means of encapsulation (e.g. spray-drying, coating, extrusion, coacervation and molecular inclusion) at any time during processing, such as before extraction, during extraction, after extraction, during drying, after drying, after grinding or after packaging. Some embodiments utilize microencapsulation. With encapsulation, an encasing layer is attained, for example, via molecular, interfacial, colloidal and bulk physicochemical properties of emulsions. The encasement reduces the reactivity of the core with regard to outside environment, for example, oxygen and water. This permits the extension of shelf life of a product in conventional packaging applications. In some embodiments, encapsulation can be used for controlled release of the inner material or core. The encased pulverized product can remain inactive until direct contact with water. Then the water can dissolve the encasement and the pulverized product is able to react with water, releasing aromas and flavors.

In some embodiments, the encapsulation of the extract can be used to optimize product functionality, particle size and/or create a new product form. Encapsulation can be done with one or more products including, for example, coffee, coffee extracts, coffee concentrates, dry pulverized coffee, coffee oils or other oils, aromas, functional ingredients, carbohydrates, soy products, dairy products, corn syrup, hydrocolloids, polymers, waxes, fats, vegetable oils, gum arabic, lecithin, sucrose-esters, mono-diglycerides, pectin, K-carbonate, K-bicarbonate, Na-carbonate, Na₃PO₄, K₃PO₄, maltodextrin, glycerine, threitol, erythritol, xylitol, arabitol, ribitol, sorbitol, mannitol, maltitol, maltotriitol, maltotetraitol, lactitol, hydrogenated isomaltulose, hydrogented starch, liposomes, liposomes in sol-gels, shellac, hydrolyzed fats, ethyl cellulose, hydroxy propyl methylcellulose, starches, modified starches, alginate and alginic acid (e.g., sodium alginate), calcium caseinate, calcium polypectate, carboxyl cellulose, carrageenan, cellulose acetate phthalate, cellulose acetate trimellitate, chitosan, corn syrup solids, dextrins, fatty acids, fatty alcohols, gelatin, gellan gums, hydroxy cellulose, hydroxy ethyl cellulose, hydroxy methyl cellulose, hydroxy propyl cellulose, hydroxy propyl ethyl cellulose, hydroxy propyl methyl cellulose, hydroxy propyl methyl cellulose phthalate, lipids, liposomes, low density polyethylene, mono-, di- and tri-glycerides, pectins, phospholipids, polyethylene glycol, polylactic polymers, polylactic co-glycolic polymers, polyvinyl pyrrolindone, stearic acid and derivatives, xanthum and proteins, zein, gluten or other agents to protect against environmental elements.

In addition, during processing of the extract, it is possible to incorporate at least one additive to the extract at any time during processing, such as before extraction, during extraction, after extraction, during drying, after drying, after grinding or after packaging. Some examples of suitable additives include a coffee extract, concentrated coffee, dried coffee, soluble coffee, coffee oils, coffee aromas, distillates, flavor powders, flavor oils, spices, ground or pulverized cocoa beans, ground or pulverized vanilla beans, vitamins, antioxidants, nutraceuticals, dietary fiber, an omega-3 oil, an omega-6 oil, an omega-9 oil, a flavonoid, wellness components, lycopene, selenium, a beta-carotene, resveratrol, inulin, beta glucan, 1-3,1-6-beta-glucan, barley beta-glucan, barley b-glucan, a vegetable extract, a dry green coffee extract, a wet green coffee extract, pulverized coffee, ground coffee and an herbal extract, for example. Some embodiments relate to methods of creating a beverage including the extract and additional ingredients.

Some embodiments involve drying the extract as shown in block 915 of FIG. 9. Examples of drying include spray freezing or spray freeze drying the extract or one or more components of a beverage. In some embodiments, spray freezing is used to convert liquid into an instant dry powder in a two step process. In the first step, liquid is sprayed or atomized over a frozen system/medium to freeze the liquid droplets. For example, one technique is to spray the liquid into a frozen chamber (e.g., in some embodiments the frozen chamber is at a temperature of less than about −30° C.) or a frozen conveyor belt. Another technique is to spray the liquid directly over (or into) liquefied gas, e.g., nitrogen, CO₂, argon, and/or other noble or inert gases contained in an appropriate container, such as, for example, a stainless steel receptacle.

The second step of the process involves transferring the frozen droplets onto shelves of a pre-frozen freeze dryer (e.g., in some embodiments, the pre-frozen freeze dryer is at a temperature of less than about −30° C.) to remove moisture via a pre-designed drying cycle. If the droplets retain any liquefied gases after the transfer, the gas can be allowed to evaporate before the freeze drying cycle is started. In another embodiment, the droplets are transferred to equipment for alternative drying, such as freeze drying, filter-mat drying, fluid bed drying, spray drying, thermal evaporation and zeodration, etc. In some embodiments, the droplets can be sprayed onto a fluidized bed of frozen/cryogenic fluids, e.g., helium, CO₂, nitrogen or the like, in a chamber/dryer. An inert gas, a noble gas or nitrogen may be used to fluidize the frozen bed and drive out moisture via sublimation, which is then trapped onto the surface of condenser coils, which are kept at a temperature of less than about −40° C., for example. In some embodiments, the temperature of the fluidizing gas is kept below the eutectic point of the frozen droplets in order to avoid melt back and/or flavor degradation. Spray freeze drying can be used to increase bulk powder flowability, improve control of particle size distribution, improve solubility and reduce thermal flavor degradation. Some embodiments also involve non-thermal evaporation or high vacuum, low temperature evaporation in the drying process.

In some embodiments, spray freezing may utilize different nozzle designs (for example, two-fluid nozzles, pressure nozzles, or ultra-sonic nozzles,) which can be used to atomize the liquid concentrate into the frozen system without becoming clogged. The size and/or shape of the spray freeze chamber, the gas inlet/outlet temperatures, the concentrate flow rates, the gas flow rates, the mode of cooling/liquefied gas, the mode of atomization, etc, can all be modified depending on the type of beverage component undergoing spray freezing or spray freeze drying and the desired beverage product.

The following examples are provided for illustrative purposes only, and are in no way intended to limit the scope of the present embodiments.

### Example 1

Green coffee beans were ground with a Fitz Mill to a particle size of from 0.5 to 2 mm. Filtered water was added to the ground product. The ratio of product to water was 1:12. Extraction of the ground product was then carried out for 30 minutes at a temperature of 79° C. The resulting mixture was centrifuged and the spent ground product discarded. The raw liquid extract was then subjected to membrane filtration with a 0.01 μm filter. The retentate from the filtration was discarded. The liquid from the filtration was then subjected to membrane filtration with a 0.005 μm filter. The retentate from the filtration was discarded. The liquid from the filtration was concentrated by an evaporator and spray dried to 97% total solids of green coffee powder.

### Example 2

Green coffee beans were ground with a Fitz Mill to a particle size of from 0.2 to 1 mm. Filtered water was added to the ground product. The ratio of product to water was 1:40. Extraction of the ground product was then carried out for 30 minutes at a temperature of 5° C. The resulting mixture was centrifuged and the spent ground product discarded. The raw liquid extract was then subjected to membrane filtration with a 0.015 μm filter. The retentate from the filtration was discarded. The liquid from the filtration was then subjected to membrane filtration with a 0.007 μm filter. The retentate from the filtration was discarded. The liquid from the filtration was concentrated by an evaporator and spray dried to 95% total solids of green coffee powder.

### Example 3

Green coffee beans were ground with a Fitz Mill to a particle size of from 0.1 to 5 mm. Filtered water was added to the ground product. The ratio of product to water was 1:2. Extraction of the ground product was then carried out for 90 minutes at a temperature of 65° C. The resulting mixture was centrifuged and the spent ground product discarded. The raw liquid extract was then subjected to membrane filtration with a 0.01 μm filter. The retentate from the filtration was discarded. The liquid from the filtration was then subjected to membrane filtration with a 0.005 μm filter. The retentate from the filtration was discarded. The liquid from the filtration was concentrated by an evaporator and spray dried to 97% total solids of green coffee powder.

### Example 4

Green coffee beans were ground with a Fitz Mill to a particle size of from 0.6 to 0.9 mm. Filtered water was added to the ground product. The ratio of product to water was 1:6. Extraction of the ground product was then carried out for 2 hours at a temperature of 85° C. The resulting mixture was centrifuged and the spent ground product discarded. The raw liquid extract was then subjected to membrane filtration with a 0.012 μm filter. The retentate from the filtration was discarded. The liquid from the filtration was then subjected to membrane filtration with a 0.004 μm filter. The retentate from the filtration was discarded. The liquid from the filtration was concentrated by an evaporator and spray dried to 96% total solids of green coffee powder.

### Example 5

Green coffee beans were ground with a Fitz Mill to a particle size of from 0.4 to 0.8 mm. Filtered water was added to the ground product. The ratio of product to water was 1:10. Extraction of the ground product was then carried out for 60 minutes at a temperature of 75° C. The resulting mixture was centrifuged and the spent ground product discarded. The raw liquid extract was then subjected to membrane filtration with a 0.01 μm filter. The retentate from the filtration was discarded. The liquid from the filtration was then subjected to membrane filtration with a 0.005 μm filter. The retentate from the filtration was discarded. The liquid from the filtration was concentrated by an evaporator and spray dried to 97% total solids of green coffee powder.

### Example 6

Green coffee beans are ground with a Fitz Mill to a particle size of from 0.5 to 2 mm. Filtered water is added to the ground product. The ratio of product to water is 1:12. Extraction of the ground product is then carried out for 30 minutes at a temperature of 79° C. The resulting mixture is centrifuged and the spent ground product discarded. An enzyme is added to the liquid extract to aggregate carbohydrates within the extract. The liquid extract is then subjected to membrane filtration with a 0.001 μm filter. The retentate from the filtration is discarded. The liquid from the filtration is then subjected to membrane filtration with a 0.005 μm filter. The retentate from the filtration is discarded. The liquid from the filtration is concentrated by an evaporator and spray dried to 98% total solids of green coffee powder.

### Example 7

Green coffee beans are ground with a Fitz Mill to a particle size of from 0.6 to 1 mm. Filtered water is added to the ground product. The ratio of product to water is 1:20. Extraction of the ground product is then carried out for 30 minutes at a temperature of 80° C. The resulting mixture is centrifuged and the spent ground product discarded. An enzyme is added to the liquid extract to aggregate sucrose within the extract. The liquid extract is then subjected to membrane filtration with a 0.001 μm filter. The retentate from the filtration is discarded. The liquid from the filtration is then subjected to membrane filtration with a 0.005 μm filter. The retentate from the filtration is discarded. The liquid from the filtration is concentrated by an evaporator and spray dried to 97% total solids of green coffee powder.

### Example 8

Green coffee beans were ground with a Fitz Mill to a particle size of from 0.6 to 1 mm. Filtered water was added to the ground product. The ratio of product to water was 1:20. Extraction of the ground product was then carried out for 30 minutes at a temperature of 80° C. The resulting mixture was centrifuged and the spent ground product discarded. The enzyme sucrase is added to the liquid extract to aggregate sucrose within the extract. The liquid extract is then subjected to membrane filtration with a 0.001 μm filter. The retentate from the filtration is discarded. The liquid from the filtration is then subjected to membrane filtration with a 0.005 μm filter. The retentate from the filtration is discarded. The liquid from the filtration is concentrated by an evaporator and spray dried to 98% total solids of green coffee powder.

While the present embodiments have been described with respect to the foregoing, those skilled in the art will readily appreciate that various changes and/or modifications can be made to the invention without departing from the spirit or scope of the embodiments as defined by the appended claims. In addition, while certain aspects of the present embodiments are presented below in certain claim forms, the inventors contemplate the various aspects of the invention in any available claim form.

Disjunctive language such as the phrase “at least one of X, Y, or Z,” unless specifically stated otherwise, is otherwise understood with the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Those skilled in the art will also appreciate that in some embodiments the functionality provided by the components, structures, methods and processes discussed above may be provided in alternative ways, such as being split among more components or methods or consolidated into fewer components or methods. In addition, while various methods may be illustrated as being performed in a particular order, those skilled in the art will appreciate that in other embodiments the methods may be performed in other orders and in other manners.

Some embodiments relate to a method of making an edible extract product comprising: providing an edible raw material reduced to particles; extracting the particles of the edible raw material in water to produce an extract of the edible raw material; filtering the extract of the edible raw material with at least one filter such that both the concentration of chlorogenic acids in the extract of the edible raw material increases and the concentration of fat in the extract of the edible raw material decreases; and separating resulting filter retentate from the filtered extract of the edible raw material to form the edible extract product.

In some embodiments, the edible raw material comprises coffee.

In some embodiments, the coffee comprises non-decaffeinated, partially decaffeinated, and fully decaffeinated coffees.

In some embodiments, the edible raw material comprises at least one of partially roasted coffee, light roasted coffee, dark roasted coffee, or green coffee.

In some embodiments, the edible raw material comprises green coffee beans.

In some embodiments, filtering the extract of the edible raw material comprises at least doubling the concentration of chlorogenic acids in the extract of the edible raw material.

In some embodiments, filtering the extract of the edible raw material comprises at least at least halving the concentration of fat in the extract of the edible raw material.

In some embodiments, the at least one filter comprises a membrane filter.

In some embodiments, filtering the extract of the edible raw material comprises the use of two filters.

In some embodiments, the two filters each allow different sizes of particles to pass.

In some embodiments, the first filter allows a larger size of particle to pass than the second filter.

Some embodiments relate to adding an enzyme to the extract of the edible raw material prior to filtering the extract of the edible raw material.

In some embodiments, the enzyme aggregates carbohydrates.

In some embodiments, the enzyme is sucrase.

In some embodiments, the extracting in conducted at a temperature of from about 5° C. to about 180° C.

In some embodiments, the extracting is conducted for from about five minutes to about twenty-four hours.

Some embodiments comprise adding to the extract of the edible raw material at least one of caffeine, chlorogenic acids, or flavoring.

Some embodiments comprise condensing the edible extract product.

Some embodiments comprise drying the edible extract product.

In some embodiments, the drying comprises spray drying.

Some embodiments comprise packaging and/or storing the edible extract product in a container.

Some embodiments comprise at least partially removing oxygen from the container.

In some embodiments, the container has an oxygen content of from about 0.1% to about 21%.

Some embodiments relate to method of producing an extract comprising: providing an edible raw material reduced to particles; extracting the particles of the edible raw material in water to produce an extract of the edible raw material; filtering the extract of the edible raw material with a first filter such that both the concentration of chlorogenic acids in the extract of the edible raw material increases and the concentration of fat in the extract of the edible raw material decreases in resulting first filtered extract of the edible raw material;

separating resulting first filter retentate from the first filtered extract of the edible raw material; filtering the first filtered extract of the edible raw material with a second filter such that both the concentration of chlorogenic acids in the filtered extract of the edible raw material increases and the concentration of fat in the filtered extract of the edible raw material decreases in resulting second filtered extract of the edible raw material; and separating resulting second filter retentate from the second filtered extract of the edible raw material to form the edible extract product.

In some embodiments, the first filter allows different sizes of particles to pass than the second filter.

In some embodiments, the edible raw material comprises coffee.

In some embodiments, the edible raw material comprises green coffee beans.

In some embodiments, the method comprises at least doubling the concentration of chlorogenic acids in the extract of the edible raw material.

In some embodiments, the method comprises at least at least halving the concentration of fat in the extract of the edible raw material.

In some embodiments, the at least one the first filter or the second filter comprises a membrane filter.

Some embodiments relate to an edible green coffee extract comprising:

at least 18 weight percent of chlorogenic acids; and

less than 0.05 weight percent of fat.

Some embodiments relate to an extract with at least 6 weight percent of caffeine.

Some embodiments relate to an edible green coffee extract comprising:

at least 18 weight percent of chlorogenic acids; and a color L* value of at least 78.

The edible green coffee extract according to claim 33, further comprising:

at least 6 weight percent of caffeine.

Some embodiments relate to a substantially alcohol-free green coffee extract comprising: at least 18 percent chlorogenic acids by weight.

Some embodiments relate to a green coffee extract comprising: at least three times as much chlorogenic acids content by weight percent as that naturally occurring in the green coffee used to produce the extract; and at least three times less fat content by weight percent as that naturally occurring in the green coffee used to produce the extract.

Some embodiments relate to at least 1.5 times the caffeine content by weight percent as that naturally occurring in the green coffee used to produce the extract.

Some embodiments relate to a green coffee extract comprising: at least three times as much chlorogenic acids content by weight percent as that naturally occurring in the green coffee used to produce the extract; and a color L* value of at least 78.

Some embodiments relate to at least 1.5 times the caffeine content by weight percent as that naturally occurring in the green coffee used to produce the extract.

Some embodiments relate to an alcohol-free green coffee extract comprising:

at least three times as much chlorogenic acids content by weight percent as that naturally occurring in the green coffee used to produce the extract.

Some embodiments relate to at least 1.5 times the caffeine content by weight percent as that naturally occurring in the green coffee used to produce the extract.

Some embodiments relate to a green coffee extract comprising: a chlorogenic acids to caffeine ratio of less than four; and a fat content of less than 0.05 percent by weight.

Some embodiments relate to green coffee extract comprising: a chlorogenic acids to caffeine ratio of less than four; and a color L* value of at least 78.

Some embodiments relate to an alcohol-free green coffee extract comprising: a chlorogenic acids to caffeine ratio of less than four.

Some embodiments relate to a substantially alcohol-free extract comprising:

a chlorogenic acids to caffeine ratio of less than four.

Some embodiments relate to an edible composition comprising:

an extract of an edible raw material, wherein the extract comprises a greater amount of chlorogenic acid and a lower amount of fat than the edible raw material from which the extract was obtained, and, wherein the extract has a flavor threshold of about 30 ppm or higher.

In some embodiments, the extract has a flavor threshold of 70 ppm or higher.

In some embodiments, the edible substance comprises one or more of green coffee beans, yellow coffee beans, red coffee beans, partially roasted coffee beans and roasted coffee beans.

In some embodiments the edible substance comprises at least one of green coffee cherries, red coffee cherries, coffee flowers, coffee cherry skin, coffee cherry pulp, coffee cherry stalk, coffee cherry silverskin, coffee cherry mucilage, coffee cherry parchment, coffee cherry exocarp, green coffee beans or coffee cherry mesocarp.

Some embodiments relate to at least one of a coffee extract, concentrated coffee, dried coffee, coffee oils, soluble coffee, coffee aromas, distillates, flavor powders, flavor oils, spices, ground or pulverized cocoa beans, ground or pulverized vanilla beans, vitamins, antioxidants, wellness components, nutraceuticals, dietary fiber, an omega-3 oil, an omega-6 oil, an omega-9 oil, a flavonoid, lycopene, selenium, a beta-carotene, resveratrol, inulin, beta glucan, 1-3,1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee or an herbal extract.

Some embodiments relate to a beverage comprising an edible composition comprising: an extract of an edible raw material, wherein the extract comprises a greater amount of chlorogenic acid and a lower amount of fat than the edible raw material from which the extract was obtained, and, wherein the extract has a flavor threshold of about 30 ppm or higher.

In some embodiments, the extract has a flavor threshold of 70 ppm or higher.

In some embodiments, the edible substance comprises one or more of green coffee beans, yellow coffee beans, red coffee beans, partially roasted coffee beans and roasted coffee beans.

In some embodiments, the edible substance comprises at least one of green coffee cherries, red coffee cherries, coffee flowers, coffee cherry skin, coffee cherry pulp, coffee cherry stalk, coffee cherry silverskin, coffee cherry mucilage, coffee cherry parchment, coffee cherry exocarp, green coffee beans or coffee cherry mesocarp.

Some embodiments relate to at least one of a coffee extract, concentrated coffee, dried coffee, coffee oils, soluble coffee, coffee aromas, distillates, flavor powders, flavor oils, spices, ground or pulverized cocoa beans, ground or pulverized vanilla beans, vitamins, antioxidants, wellness components, nutraceuticals, dietary fiber, an omega-3 oil, an omega-6 oil, an omega-9 oil, a flavonoid, lycopene, selenium, a beta-carotene, resveratrol, inulin, beta glucan, 1-3,1-6-beta-glucan, barley beta-glucan, barley b-glucan, a vegetable extract, a dry green coffee extract, a wet green coffee extract, pulverized coffee, roast coffee, roast and ground coffee, soluble coffee including pulverized coffee or an herbal extract.

What is claimed is:

1. A method of making an edible extract product comprising:
providing an edible raw material reduced to particles;
extracting the particles of the edible raw material in water to produce an extract of the edible raw material;
filtering the extract of the edible raw material with at least one filter such that both the concentration of chlorogenic acids in the extract of the edible raw material increases and the concentration of fat in the extract of the edible raw material decreases; and
separating resulting filter retentate from the filtered extract of the edible raw material to form the edible extract product.

2. The method of claim 1, wherein the edible raw material comprises coffee.

3. The method of claim 2, wherein the coffee comprises non-decaffeinated, partially decaffeinated, and fully decaffeinated coffees.

4. The method of claim 2, wherein the edible raw material comprises at least one of partially roasted coffee, light roasted coffee, dark roasted coffee, and green coffee.

5. The method of claim 1, wherein the edible raw material comprises green coffee beans.

6. The method of claim 1, wherein filtering the extract of the edible raw material comprises at least doubling the concentration of chlorogenic acids in the extract of the edible raw material.

7. The method of claim 1, wherein filtering the extract of the edible raw material comprises at least halving the concentration of fat in the extract of the edible raw material.

8. The method of claim 1, wherein the at least one filter comprises a membrane filter.

9. The method of claim 1, wherein filtering the extract of the edible raw material comprises the use of two filters.

10. The method of claim 9, wherein the two filters each allow different sizes of particles to pass.

11. The method of claim 9, wherein the first filter allows a larger size of particle to pass than the second filter.

12. The method of claim 1, further comprising adding an enzyme to the extract of the edible raw material prior to filtering the extract of the edible raw material.

13. The method of claim 12, wherein the enzyme aggregates carbohydrates.

14. The method of claim 12, wherein the enzyme is sucrase.

15. The method of claim 1, wherein the extracting is conducted at a temperature of from about 5° C. to about 180° C.

16. The method of claim 1, wherein the extracting is conducted for from about five minutes to about twenty-four hours.

17. The method of claim 1, further comprising adding to the extract of the edible raw material at least one of caffeine, chlorogenic acids, and flavoring.

18. The method of claim 1, further comprising condensing the edible extract product.

19. The method of claim 1, further comprising drying the edible extract product.

20. The method of claim 19, wherein the drying comprises spray drying.

21. The method of claim 1, further comprising packaging and/or storing the edible extract product in a container.

22. The method of claim 21, further comprising at least partially removing oxygen from the container.

23. The method of claim 22, wherein the container has an oxygen content of from about 0.1% to about 21%.

24. A method of producing an extract comprising:
providing an edible raw material reduced to particles;
extracting the particles of the edible raw material in water to produce an extract of the edible raw material;
filtering the extract of the edible raw material with a first filter such that both the concentration of chlorogenic acids in the extract of the edible raw material increases and the concentration of fat in the extract of the edible raw material decreases in resulting first filtered extract of the edible raw material;
separating resulting first filter retentate from the first filtered extract of the edible raw material;
filtering the first filtered extract of the edible raw material with a second filter such that both the concentration of chlorogenic acids in the filtered extract of the edible raw material increases and the concentration of fat in the filtered extract of the edible raw material decreases in resulting second filtered extract of the edible raw material;
separating resulting second filter retentate from the second filtered extract of the edible raw material to form the edible extract product.

25. The method of claim 24, wherein the first filter allows different sizes of particles to pass than the second filter.

26. The method of claim 24, wherein the edible raw material comprises coffee.

27. The method of claim 24, wherein the edible raw material comprises green coffee beans.

28. The method of claim 24, wherein the method comprises at least doubling the concentration of chlorogenic acids in the extract of the edible raw material.

29. The method of claim 24, wherein the method comprises at least halving the concentration of fat in the extract of the edible raw material.

30. The method of claim 24, wherein at least one of the first filter and the second filter comprises a membrane filter.
